(19) United States
(12) Patent Application Publication
(10) Pub. No.: US 2007/0054243 A1
(43) Pub. Date: Mar. 8, 2007

(54) Method and apparatus for treating dentin sensitivity

(76) Inventors: Jurgen Schemmer, King City (CA); Walter A. Hackler, Newport Beach, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/220,499

(22) Filed: Sep. 7, 2005

(51) Int. Cl. A61C 5/00; A61C 17/00

(52) U.S. Cl. 433/215; 433/80

(57) ABSTRACT

A method of treating dentin sensitivity in a patient includes applying oxidizing gas onto the dentin, monitoring the dentine sensitivity and in response to the monitoring, seizing application of the oxidizing gas. Apparatus for treating dentin sensitivity includes a source of oxidizing gas, a handpiece for delivering the gas to a tooth with dentin sensitivity, a cup attached to the handpiece for receiving the gas and exposing a selected area of the tooth to the gas and means for eliciting a response from the patient in re of the dentin sensitivity.

The present invention is directed to a method and apparatus for reducing dental sensitivity particularly sensitivity resulting from exposed dentin that has lost its natural coverings of enamel or cementum.

Dentin is 25% fluid by volume, which is located almost completely within the tubules. The diameter of the tubules averages 2.5 microns at the pulp and 0.8 microns at cementum side. The tubules are devoid of nerve tissue except for very short extensions. The nerve cell bodies reside in the pulp and sense only pain. Over time the pulp may lay down additional dentin in the tubules known as reparative dentin which may produce long-term relief from hypersensitivity. However, short-term relief usually comes either from surface occlusion of the dentinal tubules by calcified materials or from a direct desensitizing effect on the pulpal tissues.

When the dentinal tubules become exposed to the oral cavity by trauma, disease, or by dental treatment, many patients experience some hypersensitivity, usually to cold. Exposed root surfaces are a prerequisite for dentinal hypersensitivity, but not all exposed dentin is hypersensitive. It is virtually impossible to predict which patients will experience dentinal hypersensitivity. Gingival recession causing exposure of dentin can result from destructive mechanical habits, ongoing tooth eruption as adjacent teeth are lost, and the result of prominent tooth position in the arch resulting in dehiscences.

Loss of gingival attachment may also occur due to periodontal diseases, the intentional outcome of periodontal surgery for pocket reduction and toothbrush/dentifrice abrasion. Root planning or even overly aggressive rubber cupping and jet polishing may cause minor gingival recession. Even patients who improve their oral hygiene practices can experience some gingival recession as a result of shrinkage of gingival tissues as inflammation resolves.

The differential diagnosis of teeth with dentinal hypersensitivity includes a list of reasons that patients may perceive intraoral discomfort. Carious lesions often manifest discomfort that is similar to dentinal hypersensitivity. It is also very common for teeth that have had recent restorative treatment to exhibit symptoms of pain upon exposure to cold or hot. Other restorative problems that may exhibit similar symptoms include open or defective margins on restorations, recurrent caries, or fractured restorations.

Patients that have had recent scaling and root planning often experience transient dentinal hypersensitivity. Also included in the differential diagnosis for hypersensitive dentin are sinusitis, pulpal necrosis, cracked tooth syndrome, and hyperemia from hyperocclusion, bruxism or parafunctional habits. Any condition that causes facial pain may be described as hypersensitivity by the patient, including myofascial pain or temporomandibular disorders. All of these entities can potentially react to mechanical, chemical, or thermal stimuli, but they can easily be differentiated from hypersensitive dentin by the appropriate tests.

There are many stimuli that can potentially produce discomfort in patients with dentinal hypersensitivity. Pain-producing stimuli are generally grouped as follows: mechanical-toothbrush contact, instrument touch, desiccation with air; chemical—citrus, sour, or sweet foods and beverages, and acidic bacterial plaque by-products; and thermal—extremes of hot or cold food, liquids, or inhaled air.

Over the years several theories about the mechanism of tooth pain transmission have been espoused. The most widely accepted is the “hydrodynamic” theory, which suggests that pain-producing stimuli cause the fluid in the tubules to move, thus triggering the nerve receptor at the pulpal end of the tubule. The perception of pain seems to be modified by systemic mechanisms within the individual and the patient's ability to produce natural painkillers such as endorphins. This is apparent in individuals who are already experiencing other forms of stress who will report heightened dentinal sensitivity.

Treatment choices are based on the patient profile, history, and clinical evidence. The features of an ideal treatment for dentinal hypersensitivity would be one which is not painful, easy to apply, rapid acting, profound in effect, long lasting, non-staining, predictable, and not irritating to the pulp. This ideal treatment could be applied by the patient, by the dental professional, or both. Unfortunately, the ideal treatment for dentinal hypersensitivity has not yet been developed, so the dental professional must use the available treatments in a logical sequence to achieve relief for the patient.

The present invention provides for such an ideal treatment.

### SUMMARY OF THE INVENTION

A method in accordance with the present invention for treating dentin sensitivity in a patient generally includes applying an oxidizing gas onto the dentin, monitoring the dentin sensitivity, and in response to the monitoring, ceasing application of the oxidizing gas. More particularly, the oxidizing gas includes gaseous ozone which is applied onto the dentin.

The application to the dentin may be done through carious lesions or alternatively, the application of ozone onto the dentin may include application of gaseous ozone dome through cementum.

Still, another method for applying gaseous ozone onto the dentin includes applying gaseous ozone through a cracked tooth.

More specifically, monitoring the dentin sensitivity may include exposing a tooth with dentin sensitivity to a hot or cold temperature and eliciting a response from the patient.

Alternatively, the monitoring of dentine sensitivity may include exposing a tooth with dentin sensitivity to a chemical and eliciting a response from the patient. Pressure may also be applied to the tooth.

Any suitable monitoring system may be utilized such as any set forth in U.S. Pat. No. 5,984,368, “Patient Condition and Pain Location Intensity Communication Apparatus and the Method”, issued Nov. 16, 1989. This patent is to be incorporated herewith in its entirety by this specific reference thereto or examples of monitoring dentin sensitivity.

A method of treating dentin sensitivity may alternatively be considered as penetrating dentin tubuli with an oxidizing gas, monitoring the dentin sensitivity, and in response to the monitoring, ceasing penetration of the dentin tubuli with oxidizing gas.

Apparatus for treating dentin sensitivity in a patient generally includes a source of oxidizing gas, a handpiece for delivering gas to a tooth with dentin sensitivity along with a cup attached to the handpiece for receiving the gas and exposing a selected area of the tooth to the gas.

Additionally, means are provided for eliciting a response from the patient in regard to the dentin sensitivity. The hereinabove incorporated U.S. Pat. No. 5,984,368 also provides apparatus which may be useful in accordance with the present invention and is further incorporated by this reference support for that purpose.

The apparatus further includes ozone as the oxidizing gas and in addition a source of reductant may be provided and interconnected with the handpiece for flushing the gas from the cup.

Further, the source of oxidizing gas may include an ozone pump and an aspiration pump may be provided along with an aspiration line connected to the handpiece coordinate with circulation of the gas into another cup.

In addition, a controller may be provided for regulating the ozone and aspiration pumps in order to circulate the gas in and out of the cup at a pressure insufficient to escape past a ceiling engaged between the cup and the tooth.

Still more particularly, the means for eliciting a response from the patient may include an applicator for introducing hot or cold gas or liquid to the tooth. Alternatively, the means for electing a response from the patient may include an applicator for introducing a chemical to the tooth or pressure onto the tooth.

### BRIEF DESCRIPTION OF THE DRAWINGS

The advantages and features of the present invention will be better understood by the following description when considered in conjunction with the accompanying drawings, in which:

FIG. 1 illustrates a block diagram of apparatus for treatment of dentin sensitivity in accordance with the present invention, the apparatus generally includes a source of oxidizing gas, an aspiration pump, a source of reductant, a reductant pump and a controller for providing the oxidizing gas to a handpiece;

FIG. 2 illustrated a handpiece in accordance with the present invention for delivering a gas to a tooth and generally showing a cup attached to the handpiece for receiving the gas;

FIG. 3 illustrated the handpiece with an alternative cup embodiment, the alternative embodiment cup having an arcuate shape for facilitating application of oxidizing gas to a tooth;

FIG. 4 is a diagram showing application of oxidizing gas to a tooth between a cusp and a gingival utilizing the handpiece and cup shown in FIG. 3, along with an applicator for providing temperature, chemical, or pressure stimuli to the tooth in a conventional manner;

FIG. 5 is cross-sectional view of the cup shown in FIG. 2 that is suitable for use in the present invention;

FIG. 6 is a cross sectional view an alternative embodiment of a cup for exposing a selected area of a tooth oxidizing gas;

FIG. 7 is a cross sectional diagram showing an alternative embodiment of a cup in accordance with the present invention for exposing adjacent teeth to oxidizing gas;

FIG. 8 illustrates the use of the cup shown in FIG. 7 as it may be applied to adjacent teeth.

FIG. 9 is a cross sectional representation of a tooth illustrating application of oxidizing gas to dentin tubuli through carious lesions and breached cementum; and

FIG. 10 illustrates the oxidation of amino acids present in dentin fluid.

### DETAILED DESCRIPTION

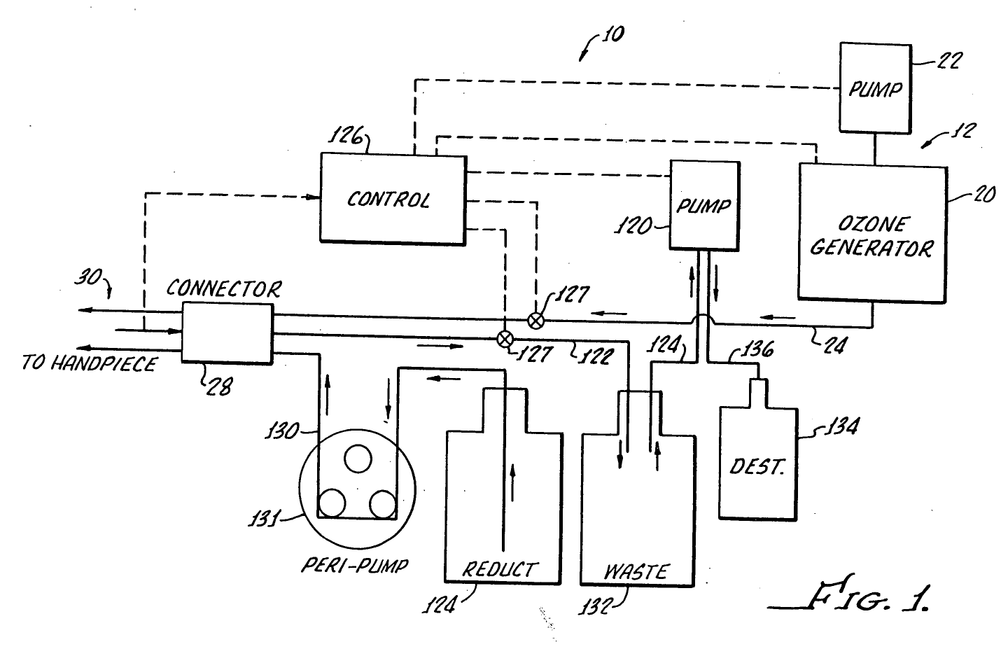

With reference to FIGS. 1-4, there is shown apparatus 10 in accordance with the present invention for the treatment of dentine sensitivity which includes a source 12 of oxidizing gas, preferably ozone, and a handpiece 16 (see FIG. 2) for delivering the gas to a tooth, not shown in FIGS. 1-3.

As illustrated in FIG. 1, the ozone source 12 includes an ozone generator 20 and an ozone pump 22 for supplying ozone through a line 24, a connector 28 and lines 30 to the handpiece 16. As used herein, the term “ozone” is intended to embrace any suitable oxidizing gas, pure ozone, ionized air and other ozone gaseous mixtures.

Ozone is delivered at a pressure, concentration and for a period of time sufficient to penetrate dentin tubuli and kill substantial all of the micro-organism therewith. Specific examples of the use of ozone are set forth in U.S. Pat. Nos. 6,409,508 and 6,454,566 which are to be incorporated herewith in their entirety by this specific reference thereto.

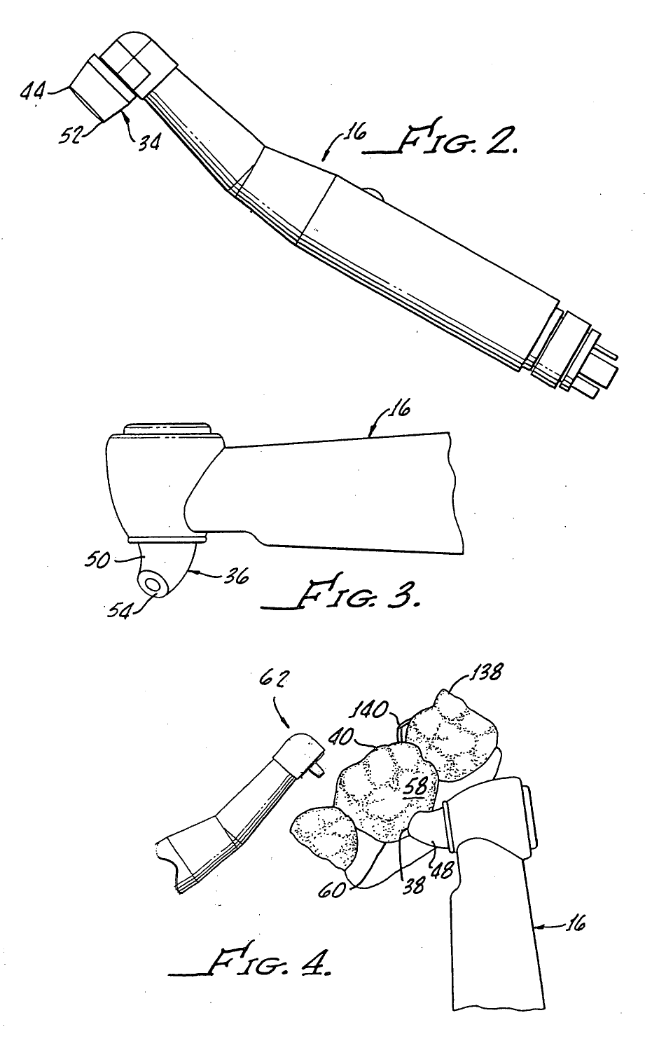

As shown in FIG. 2-3, cups 34 36 attached to the handpiece 16 are provided for receiving the gas and exposing a selected area 38 on a tooth 40, see FIG. 3. The cup 34 may be attached to the handpiece 16 in any conventional manner and include a resilient edge, or sidewall, 44 for sealable engaging the tooth 40 to prevent the escape of gas therepast.

Many different sized and shaped cups may be utilized, as for example shown in FIG. 3 the cup 36 includes an arcuate trunk 50 to facilitate the placement of the cup 36 over the selected area 38 as shown in FIG. 4. The cups 34, 36 may have relatively uniform perimeters 52, 54 for sealably engaging the tooth 40 between a cusp 58 and a gingiva 60 as shown in FIG. 4. Also shown in FIG. 4 is an implement, tool, or applicator 62 for exposing the tooth 40 to a hot or cold temperature, or chemical, or pressure, in a conventional manner.

The applicator 62 facilitates the method of the present invention which includes applying an oxidizing gas onto dentin by way of carious lesions, breached cementum, or through a cracked tooth, monitoring dentin sensitivity through the applicator with patient elicitation, and in response to the monitoring, ceasing application of the oxidizing gas.

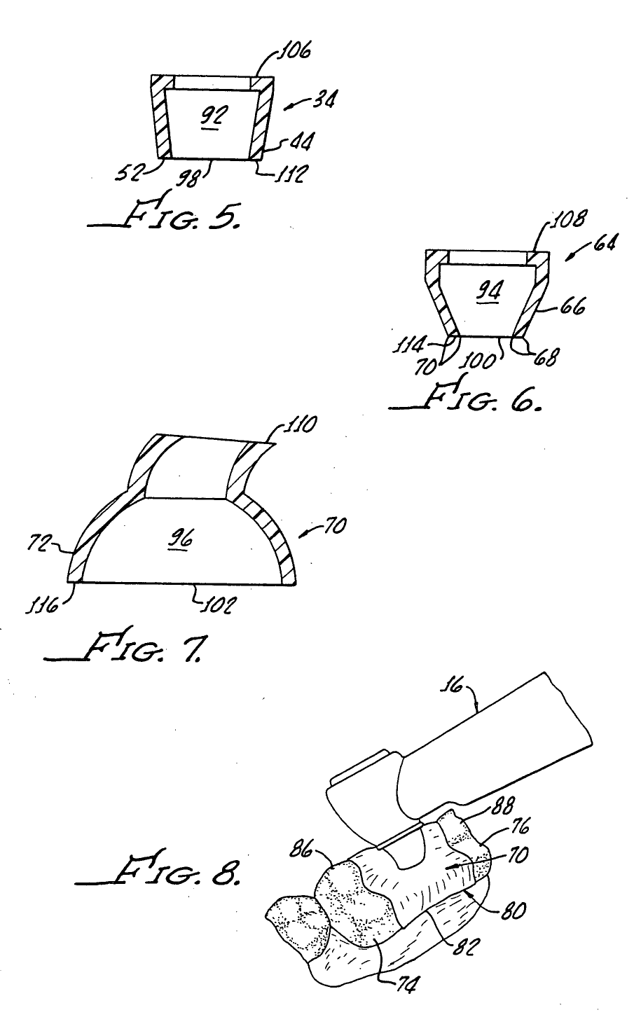

A further cup embodiment 64 is shown in cross-section in FIG. 6 includes a tapered sidewall 66 that may be used for application of oxidizing gas to a smaller selected area (not shown) on the tooth 40.

While a resilient edge or sidewall may be used to couple the cup to the selected area 38 on the tooth 40, it should be appreciated that a separate sealant 68 (See FIG. 6) may be utilized for providing a sealable engagement between the cup 64 and the tooth 40. In this instance, the sidewall 66 need not be resilient.

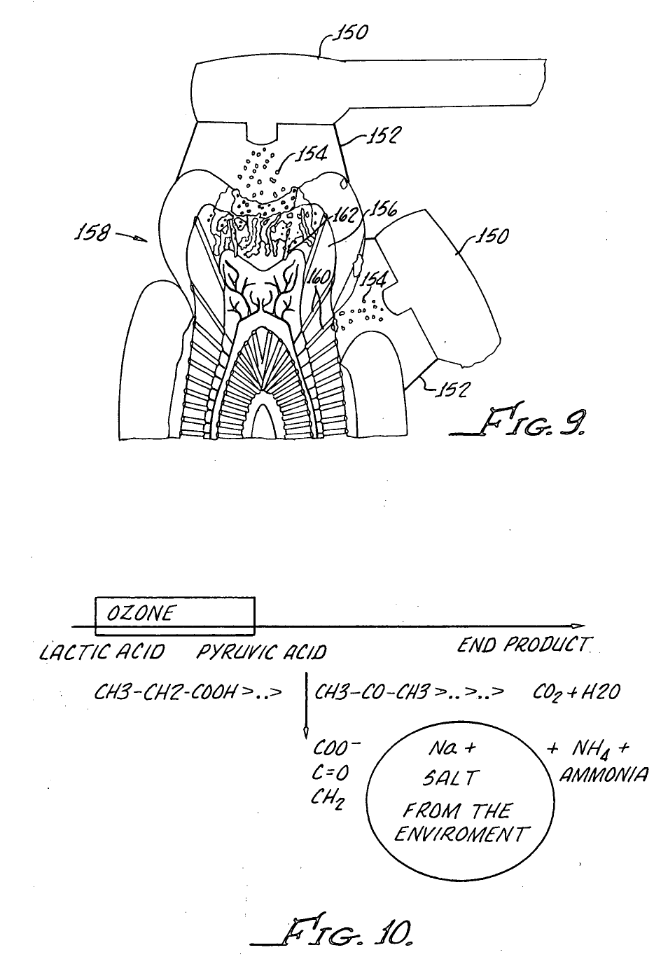

Another embodiment of a cup 70 is shown in cross-section in FIG. 7 which includes walls 72 which are contoured for enabling the sealable engagement with adjacent teeth 74, 76 as shown in FIG. 8. As shown in FIG. 8, a cup edge 80 has a perimeter contour 82 for providing a sealable engagement with cups 86, 88 of adjacent teeth 74, 76.

All of the cups 34, 64, 70, cross-sectionally illustrated in FIGS. 5-7. include cup chambers 92, 94, 96 that subtend cup edges 98, 100, 102. As shown each of the cups 34, 64, 70 include walls 44, 66, 72 that define the chambers 92, 94, 96 and include first perimeters 106, 108, 110 for sealably coupling the walls 44,66, 72 to the handpiece 16. Second perimeters 112, 114, 116 provide for coupling the walls 44,66 72 to the tooth 40 and exposing the selected areas 38 to gas circulated in the chambers 92, 94, 96.

As shown in FIG. 6, the embodiment 64 the first perimeter 108 may be larger than the second perimeter 115 or, as shown in FIG. 7, the first perimeter 110 may be smaller than the second perimeter 116. Accordingly this variation in cup 64, 70 design enables the application of oxidizing gas the any number of tooth contours and to the application of oxidizing gas to a plurality of teeth has hereinabove described.

With reference again to FIG. 1, the apparatus 12 includes an aspiration pump 120 and lines 30, 122, 124 connected to the handpiece 16 for enabling circulation of the ozone into and out of the cup chambers 92, 94, 96.

A controller 126, which may be of any conventional circuit design, is provided for regulating the ozone and aspiration pumps 22, 120 in order to circulate the gas into and out of the cup chambers 92, 94, 96 at a pressure insufficient to permit escape of the gas past a sealed engagement between the cups 34, 64, 70 and teeth 40, 86, 88. Control of the gas flows may also be effected through valves 127, 127 regulated by the controller 126.

Additionally, the apparatus 10 may include a reductant source 128, which is in fluid communication with the cup chambers 92, 94, 96 through lines 30, 130 and a parastalic pump 131. The reductant, which may be a solution of thiocyanate or peppermint, is utilized to flush the cup chambers 92, 94, 96 of oxidizing gas. The oxidizing gas is flushed into the aspiration line 122 following ozone treatment of the tooth 40, 86, 88. The reductant is then aspirated through line 122 and into a waste accumulator 132.

Any residual ozone is then aspirated from the accumulator 132 through the line 124 and into a canister 134 through line 136 for final elimination of the ozone. Thus, the apparatus 12 provides for a totally closed system for the application and removal of ozone to and from teeth 40, 86, 88.

It should also be appreciate that when the cups 34, 36, 64 are utilized between teeth 40, 138 (not shown in FIG. 4) a separate dam 140 maybe utilized as necessary to enable the cups 34, 36, 64 (not shown in FIG. 4) to sealably enclose a selected area for treatment between the teeth 40, 138.

### EXAMPLE

A method in accordance with the present invention utilizes a handpiece 150 with cup 152 to applying oxidizing gas 154 to the dentin 156 of a tooth 158 for penetrating dentin tubuli 160, 162. Typically, 99.9% of germs are killed after 20 seconds, however, for deeper lesions a time of 30-60 seconds may be utilized.

As illustrated, ozone penetrates into the tubuli and oxidizes amino acids present in the dentin fluid into CO₂ and H₂O, see FIG. 10. Nitrogen is volatile and disperses in part because of the vacuum created by the flow of ozone. This leaves only a reduced volume of amino-acids and water in the tubuli. As a result, no mechanical stimulus can be passed on for the time being, as the head of liquid is no longer strong enough to reach the entrance in the tubuli.

The acidic and metabolic products of the bacteria and the bacteria themselves are immediately dissolved by the ozone and immediately loose their effect. That means for the time being no chemical or physical transmission is present.

Accordingly, ozone ensures a germ and acid free content in the tubuli and when the patient feels the pain being relieved, by monitoring through temperature, pressure, or chemicals, the ozone has reached the tubuli and the same time has left the dentin germ-free.

It has been found that, as shown, in FIG. 10 the reaction of ozone with lactic acid proceeds over two intermediary stages and, as with any reaction, this is never fully completed. As a result, among other things, the pyruvics and cells remain in the tubulum and act as an acid buffer for some time.

In fact, it is found that this state is stable until the dentin fluid regenerates enough quantity to reach the tubulum entrance. This varies from patient to patient and is also dependent upon the success of the remineralization process within the tubulum. However, the desensitation has been found to be effective for between about 3 and about 6 months.

Although there has been hereinabove described a specific method and apparatus for treating dentin hypersensitivity in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A method of treating dentin sensitivity in a patent comprising:
applying an oxidizing gas onto the dentin;
monitoring the dentin sensitivity; and
in response to the monitoring, ceasing application of the oxidizing gas.

2. The method according to claim 1 wherein applying oxidizing gas comprises applying gaseous ozone.

3. The method according to claim 2 wherein applying gaseous ozone onto the dentin includes applying gaseous ozone through carious lesions.

4. The method according to claim 2 wherein applying gaseous ozone onto the dentin includes applying gaseous ozone through breached cementum.

5. The method according to claim 2 wherein applying gaseous ozone onto the dentin includes applying gaseous ozone through a cracked tooth.

6. The method according to claim 2 wherein monitoring the dentin sensitivity includes exposing a tooth with said dentin sensitivity to a hot or cold temperature and electing a response from the patient.

7. The method according to claim 2 wherein monitoring the dentin sensitivity includes exposing a tooth with a dentin sensitivity to a chemical and electing a response from the patient.

8. A method of treating dentin sensitivity in a patient comprising:
penetrating dentin tubuli with an oxidizing gas;
monitoring the dentin sensitivity; and
in response to the monitoring, ceasing penetrating of dentin tubuli with oxidizing gas.

9. The method according to claim 8 wherein applying oxidizing gas comprises applying gaseous ozone.

10. The method according to claim 9 wherein penetrating tenline tubuli includes passing gaseous ozone through carious lesions.

11. The method according to claim 9 wherein penetrating dentin tubuli includes passing gaseous ozone through breached cementum.

12. The method according to claim 9 wherein penetrating dentin tubuli includes passing gaseous ozone through a cracked tooth.

13. The method according to claim 9 wherein monitoring the dentin sensitivity includes exposing a tooth with said dentin sensitivity to a hot or cold temperature and eliciting a response from the patient.

14. The method according to claim 9 wherein monitoring the dentin sensitivity includes exposing a tooth with said dentin sensitivity to a chemical and eliciting a response from the patient.

15. The method according to claim 9 wherein monitoring the dentin sensitivity includes exposing a tooth with dentin sensitivity to pressure and eliciting a response from the patient.

16. Apparatus for treating dentin sensitivity in a patent, said apparatus comprising:
a source of oxidizing gas;
a handpiece for delivering the gas to a tooth with dentin sensitivity;
a cup attached to said handpiece for receiving the gas and exposing a selected area of the tooth to the gas; and
means for eliciting a response from the patient in re the dentin sensitivity.

17. The apparatus according to claim 16 wherein said oxidizing gas comprises ozone.

18. The apparatus according to claim 16 further comprises a source of reductant interconnected with said handpiece for flushing the gas from said cup.

19. The apparatus according to claim 16 wherein said source of oxidizing gas includes an ozone pump and further comprising an aspiration pump and an aspiration line connected to said handpiece for enabling circulation of the gas into and out the cup.

20. The apparatus according to claim 19 further comprising a controller for regulating the ozone and aspiration pumps in order to circulate the gas into and out of the cup at a pressure insufficient to escape past a sealed engagement between the cup and the tooth.

21. The apparatus according to claim 18 further comprising a reductant pump for circulating the reductant through the cup to flush the oxidizing gas from the cup and into said aspiration line.

22. The apparatus according to claim 21 further comprising a waste accumulator connected to said aspiration line for receiving the reductant.

23. The apparatus according to claim 22 further comprising a filter for removal of any residual oxidizing gas from the aspiration line.

24. The apparatus according to claim 16 wherein said means for electing a response from the patient includes an applicator for introducing a hot or cold gas or liquid to the tooth.

25. The apparatus according to claim 16 wherein said means for electing a response from the patient includes an applicator for introducing a chemical to the tooth.

26. The apparatus according to claim 16 wherein said means for eliciting a response from the patient includes an applicator for putting pressure onto the tooth.
